(19) United States
(12) Patent Application Publication
(10) Pub. No.: US 2007/0190484 A1
(43) Pub. Date: Aug. 16, 2007

(54) CLOSED LOOP SPEED CONTROL FOR A PNEUMATIC DENTAL HANDPIECE

(75) Inventors: Kevin Brennan, Villa Park, IL (US); Timothy M. Beck, York Haven, PA (US); Eugene J. Novak, Deerfield, IL (US)

Correspondence Address: MCNEES WALLACE & NURICK, LLC, 100 PINE ST., P.O. BOX 1166, HARRISBURG, PA, 17108-1166, US

(73) Assignee: DENTSPLY INTERNATIONAL INC., York, PA (US)

(21) Appl. No.: 11/612,128

(22) Filed: Dec. 18, 2006

Related U.S. Application Data
(60) Provisional application No. 60/772,103, filed on Feb. 10, 2006.

(51) Int. Cl. A61C 1/02; A61C 1/05

(52) U.S. Cl. 433/100; 433/132

(57) ABSTRACT

A detection system for remotely determining the speed of a rotating tool tip in a pneumatic dental handpiece. A means for detecting the speed of the rotating tool tip monitors a periodic mechanical function at the pneumatic hose connected to the handpiece. The monitored periodic mechanical function serves to provide feedback that is used to control the speed of the rotating tool tip. The means for detecting the speed of the rotating tool detects a mechanical function of the rotating tool tip, which in transmitted to a controller. The controller in turn regulates the operation of an air supply valve in response to the detected mechanical function. The valve regulates the flow of air to the handpiece. By continuously adjusting the flow of air through the valve into the pneumatic hose, the speed of the rotating tool is maintained at the desired cutting speed.

### FIELD OF THE INVENTION

The present invention is directed to apparatus for controlling the rotational speed of a pneumatic dental handpiece by detecting and monitoring a periodic mechanical function produced by the handpiece.

### BACKGROUND OF THE INVENTION

In dental treatments with current pneumatic handpieces, a tool tip or burr is rotated at a speed higher than the desired cutting speed. These speeds can be as high as 450,000 revolutions per minute (rpm). When cutting load is applied, this pneumatic system is slowed significantly, adversely affecting cutting capability. The dental practitioner must maintain a useful system speed for cutting by carefully balancing cutting load and pneumatic pressure in order to properly accomplish the cutting operation. Water is also typically provided during the cutting operation to cool the cutting surface as well as the tool surface.

Knowledge of the speed of the rotating burr and/or the rotating turbine under load is desirable and necessary to control speed at a useful value. Prior art devices detect the rotating speed of a pneumatic handpiece by a magnetic resistance element, or elastic control elements assembled near the tool tip.

For example, U.S. Pat. No. 5,567,154 issued to Wohlgemuth on Oct. 22, 1996, entitled “Dental Turbine Drive Having Means of Automatic Speed Control,” (the '154 patent) and U.S. Pat. No. 5,496,173 issued to Wohlgemuth on Mar. 5, 1996, entitled “Dental Handpiece Having an Automatically Controlled Turbine Drive,” (the '173 patent) both disclose speed control by a control element in the form of a proportional valve placed in an air turbine exhaust path that throttles open as the turbine speed is decreased due to lowered centrifugal force on an elastic element, and conversely throttles closed as the turbine speed is increased. The control element adds cost and complexity to the handpiece. Such a control element also is subject to degradation during sterilization of the handpiece. The '154 patent further includes as a second element a pressure chamber that responds to changes in pressure to further support the control element. Devices incorporating these features are currently being marketed.

U.S. Pat. No. 4,493,643 issued Jan. 15, 1985, to Tachibana, entitled “Dental Handpiece Having Non-contact Rotational Speed Detection Device” (the '643 patent) discloses speed detection by a cylindrical rotor of magnetic material and coil windings to produce an induction pulse generator. Such detection means adds cost and complexity to the handpiece and also is subject to degradation during required sterilization of the handpiece.

U.S. Pat. No. 3,865,505 issued to Flatland on Feb. 11, 1975, entitled “Speed Governor for a Dental Handpiece,” (the '505 patent) discloses speed control by a proportional bypass valve placed in the turbine supply path that throttles open as the turbine speed is decreased due to lowered discharge pressure in the exhaust channel, and conversely throttles closed as the turbine speed is increased. It too is inferior because it adds cost and complexity to the handpiece, and its control apparatus is subject to degradation during sterilization of the handpiece. Devices incorporating these features are currently being marketed.

These prior art methods are impractical or undesirable as they add cost to the handpiece. These devices also can require relatively large structures within the handpiece, making them difficult and uncomfortable to hold, while also leading to integration problems as a result of this bulky but required size. Depending on the design, the sensors/control elements of these prior art units also can be difficult to protect from damage during handpiece sterilization. What is desired is a detection system that remotely detects the drill speed and regulates the drill speed based on the detected drill speed. Such a system does not rely on detecting exhaust pressure to determine rotational speed. Ideally, the detection system is not subject to damage as a result of handpiece sterilization.

### SUMMARY OF THE INVENTION

A detection system remotely determines the speed of a rotating tool tip in a pneumatic dental handpiece. The present invention does not rely on a control element operated by exhaust air pressure that is installed in a handpiece. The dental handpiece has a proximal end and a distal end, the rotating tool tip, also referred to as a bur, being located at the distal end. A means for detecting the speed of the rotating tool tip monitors a periodic mechanical function at a location away from the distal end of the handpiece, such as at or within a fluid hose, such as a pneumatic hose, connected to the handpiece. The monitored periodic mechanical function is related to the rotational speed of the tool tip. The monitored periodic mechanical function serves to provide feedback that is used to control the speed of the rotating tool tip.

The means for detecting the speed of the rotating tool is in communication with a controller. It detects a mechanical function associated with the rotating tool tip, which is transmitted to the controller, typically as a signal. The controller receives the signal, calculates the rotational speed of the rotating tip, compares the calculated speed to a pre-set speed range and regulates the operation of a fluid supply valve in response to the detected mechanical function by adjusting the valve to meter the flow of a drive fluid to maintain the rotational speed of the tip within the pre-set speed range. The valve thus regulates the flow of the drive fluid, preferably air under pressure, to the handpiece. By continuously adjusting the flow of the pressurized drive fluid through the valve, as required, into the pneumatic hose, the speed of the rotating tool is maintained within the desired cutting speed range.

The present invention relies on a means for detecting a mechanical function related to the speed of the tip, such as a vibration, that is located away from a distal end of the handpiece, such as within the pneumatic hose. Thus, it does not necessarily rely on “cylindrical rotor of magnetic material” and/or coil windings to produce an “induction pulse generator,” which is difficult to sterilize. Since it is not installed in the handpiece, such as an elastic control element operated by centrifugal force, it does not require sterilization. The means for detecting speed being located remotely from the handpiece allows the handpiece size to be both smaller as well as ergonomically designed for the comfort of the user, here the dentist. Thus, the pneumatic handpiece of the present invention can duplicate the operating “feel” of more compact electric motor handpieces

Another advantage of the present monitoring and feedback system of the present invention is that increased torque and power will be delivered by the pneumatic handpiece delivered over a wider range of operating speeds during its use.

Still another advantage of the present invention is that the tool tips, typically burs and diamonds, will have a longer life. Since the pneumatic motor can operate at a lower speed, the handpiece itself also should have a longer life in addition to generating less noise during free-running operation.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic cross sectional view of the control system for a dental handpiece of the present invention.

### DETAILED DESCRIPTION OF THE INVENTION

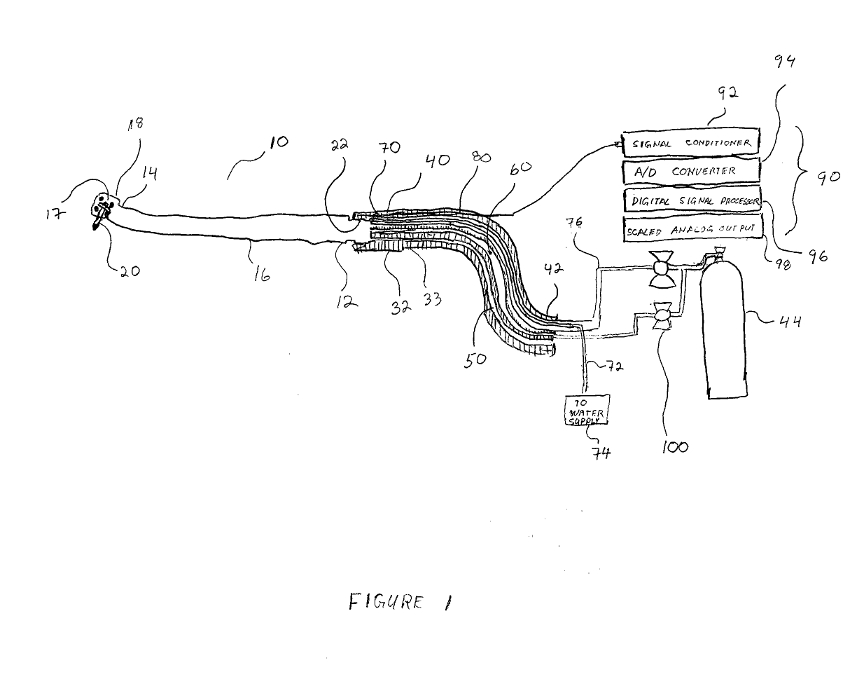

The present invention comprises a pneumatic dental handpiece 10 coupled to a pneumatic supply hose 40. The dental handpiece 10 has a proximal end 12, a distal end 14 and a body 16 extending between the proximal end 12 and the distal end 14. A handpiece head 18 is located at the distal end 14, the head housing a rotating turbine assembly 17 into which is inserted a bur 20 or tool tip. Bur 20, on assembly into head 18, extends away from the distal end 14 of the handpiece 10. Depending on the handpiece design, the bur can extend substantially parallel to an axis through handpiece 10, the axis extending between the proximal end 12 and the body 16 of the handpiece. The bur may extend substantially perpendicular to this axis. Alternatively, the bur may extend at any angle therebetween. As shown in FIG. 1, the bur extends at an angle to the axis between parallel and perpendicular. The proximal end 12 of the handpiece 10 includes a handpiece coupling 22 designed to interface with a pneumatic hose coupling 32 forming a first end of pneumatic hose 40, thereby forming an airtight joint. The pneumatic supply 40 hose preferably is flexible, having a first coupling end 33 and an opposed second end 42 connected to a pressurized air supply 44 by any suitable coupling.

The pneumatic supply hose 40 includes an air supply passageway 60 and an exhaust passageway 50 for providing drive air to the handpiece. An air supply control valve 100 is connected to the air supply passageway 60, as shown for example in FIG. 1 at the second end 42 of the supply hose 40, to regulate the flow of drive air from air supply 44 into air supply passageway 60. A water supply passageway 72 connected to a water supply 74 may also be included in supply hose 40, or a separate water supply hose connected to a water supply may be provided. Drive air from air supply 44 passes through supply valve 100 into air supply tube 60 and into the handpiece 10 to drive the turbine and attached bur. The drive air is directed from the proximal end 12 of the hand piece 10, through the handpiece to the distal end 14 where it is used to drive turbine assembly 17 and thereby tool tip 20. Return air is then transported through the handpiece to the proximal end and then to the exhaust tube 50, where it is exhausted remotely from the handpiece. A separate supply of pressurized air sometimes referred to as chip air, may be provided to interact with the water supply to provide a water spray through a separate chip air supply passageway 76. A fine mist water spray can be achieved by placing the water supply passageway 72 coaxially and within the chip air supply passageway 76.

It will be understood by those skilled in the art that while pneumatic hose 40 is shown with an air supply passageway 60 and an exhaust passage way 50, any equivalent structure that transports drive air from air supply 44 through a valve to the handpiece 10 to drive bur 20 and then exhausts the air from the handpiece may be utilized. One such structure would include separate a separate air supply tube and a separate exhaust supply tube.

The present invention further includes a means for detecting a mechanical function 70. As used herein, a mechanical function is any periodic mechanical artifact that is generated by operation of the handpiece 10. A mechanical artifact includes but is not limited to any periodic mechanical vibration of the handpiece, a pressure, an acoustic wave or an oscillation resulting from its operation. The means for detecting may also include an electrical or a magnetic speed detection means, or combination of electrical and mechanical speed detection means in the handpiece that provides an indication of the rotational speed of the bur or turbine in a periodic fashion. In a preferred embodiment, the mechanical function detected is the periodic vibration of the rotating tool transmitted through the handpiece, and preferred means for detecting this mechanical function is an accelerometer. However, depending upon the mechanical function monitored, the means for detecting may vary. The means for detecting can include a pressure transducer, a sound transducer, a linear variable differential transformer (LVDT), a microphone or an acoustic device for detecting acoustic transmissions from operation of the handpiece. A pressure transducer may be used to detect the mean pressure in the handpiece. Alternatively, the pressure transducer may be used to detect the difference in pressure between the inlet and outlet pressure or to detect pressure pulsations. The means for detecting may also be any means (optical or other) for detecting periodic vibrations in the handpiece, since such vibrations are indicative of the tool tip rotational speed. The means for detecting may also be an optical speed detection means to detect an optical signal from an optical signal generator associated with the rotating tool. The means for detection may also be a Hall Effect detector that uses magnetic and electrical impulses to determine rotational speed. In a Hall Effect device, a rotating magnet generates an electrical field, which field cam then be detected.

The means for detecting a mechanical function 70 is a detector that preferably is located in the pneumatic hose coupling 32. However, its location is not so restricted and it may alternatively be located in the flexible supply hose 40 or in the pneumatic handpiece 10 itself, although a proximal end location 12 may be preferable when size is a consideration. The present invention also contemplates detectors located in the distal end 14 when the detector can be sealed so that sterilization can be accomplished without damaging the detector. The detector can be unsealed if it is resistant to degradation due exposure to the fluids and temperatures used in the required sterilization procedures. The detector 70 is in communication with a controller 90. The signal detected by detector 70 is a periodic signal indicative of the rotational speed of tool tip 20 or air turbine assembly 17 that is transmitted to the controller 90. Although detector 70 is depicted as wired to controller 90 by means of embedded sensor wire leads 80, as shown in the accompanying FIG. 1, the present invention contemplates wireless communication between the detector 70 and the controller 90, such as by transmission of RF signals as is well known.

Controller 90 may include a signal conditioner 92, which conditions and amplifies the signal received from detector 70, an optional analog to digital (A/D) converter 94, that converts an analog signal to a digital signal if the signal transmitted by the detector 70 is not digital, a digital signal processor 96, and a scaled analog output 98. Controller 90 is in communication with air supply valve 100, which is preferably an electronically controlled air supply valve. Such a valve can be controlled with a solenoid, for example. The output of the controller opens and closes the valve as required to maintain the speed of the tip within a predetermined range. Increasing or decreasing the amount of air from the air supply through air supply valve 100 increases or decreases the speed of the tip, which airflow is controlled by the feedback from detector 70.

In a preferred embodiment, the closed loop control of a pneumatic dental handpiece is accomplished by sensing a periodic mechanical function of the handpiece indicative of the rotational speed of the tool tip, vibrations, generated by operation of the rotating tool tip 20 via a detector 70, such as an accelerometer, mounted in the hose coupling 32. The signal generated is delivered to the signal conditioner by wire leads 80 fed within the supply hose 40 back to the location of the supply valve 100. The conditioned signal then is filtered or narrowed to oscillations within the expected operating range of the instrument, and converted into a digital approximation. Within the controller 90, and specifically by digital signal processor 96, a Fourier Transform of the digital signal is calculated, and the fundamental frequency corresponding to rotational speed is selected via a logic algorithm. This rotational speed is compared against a pre-set operating speed target to calculate a proportional adjustment of the supply valve 100 to meter the proper volume of air through it.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for remotely monitoring the rotational speed of a rotating tip of a pneumatic dental handpiece, comprising:
a dental handpiece having a proximal end and a distal end;
a rotating tip located at the distal end of the handpiece;
a fluid supply;
a fluid conduit connected to the proximal end of the handpiece to provide fluid communication from the fluid supply to the handpiece to drive the rotating tip;
a means for detecting a periodic function of the handpiece indicative of the rotating tip speed of the tip, a valve to control the flow of fluid from the fluid supply into the handpiece; and
a controller in communication with the means for detecting the periodic function of the handpiece and with the valve, wherein the controller receives a signal from the means for detecting the periodic function, calculates the rotational speed of the tip, compares the calculated speed to a preset speed range, and adjusts the valve to meter fluid to the handpiece as required so that the calculated rotating speed of the tip is within the preset speed range.

2. The system of claim 1 wherein the means for detecting includes a sensor.

3. The system of claim 2 further including sensor lead wires between the sensor and the controller to provide communication between the sensor and the controller.

4. The system of claim 2 further including an RF transmitter connected to the means for detecting and an RF receiver connected to the controller to provide communication between the means for detecting and the controller.

5. The system of claim 1 wherein the controller includes a signal conditioner to condition the signal received from the means for detecting.

6. The system of claim 1 wherein the controller includes an analog to digital converter when the signal transmitted from the means for detecting is an analog signal.

7. The system of claim 1 wherein the controller includes a digital signal processor.

8. The system of claim 5 wherein the controller includes a scaled analog output.

9. The system of claim 1 wherein the means for detecting detects a periodic mechanical function generated by operation of the handpiece.

10. The system of claim 1 wherein the means for detecting is a linear variable differential transformer.

11. The system of claim 1 wherein the means for detecting is a pressure transducer.

12. The system of claim 1 wherein the means for detecting is a Hall Effect device.

13. The system of claim 1 further including a water supply passageway in communication with a water supply.

14. The system of claim 1 further including a chip air supply passageway in communication with an air supply.

15. The system of claim 13 wherein a water-air mist is produced by cooperation of the water supply passageway and the chip air supply passageway.

16. The system of claim 1 wherein the means for detecting is located remotely from the distal end of the handpiece.

17. The system of claim 1 wherein the means for detecting is located in the proximal end of the handpiece.

18. The system of claim 1 further including a hose coupling attached at one end to the fluid conduit, and at the other end to the handpiece.

19. The system of claim 18 wherein the means for detecting is positioned in the fluid conduit.

20. The system of claim 18 wherein the means for detecting is positioned in the hose coupling.
